(19) United States
(12) Patent Application Publication
(10) Pub. No.: US 2013/0257638 A1
(43) Pub. Date: Oct. 3, 2013

(54) ELECTROMAGNETIC ANECHOIC CHAMBER

(71) Applicant: XIAO-LIAN HE, Shenzhen City (CN)

(72) Inventor: XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/445,936

(22) Filed: Apr. 13, 2012

(30) Foreign Application Priority Data
Mar. 29, 2012 (CN) 201210087305.1

(51) Int. Cl. H01Q 17/00

(52) U.S. Cl. 342/1

(57) ABSTRACT

An electromagnetic anechoic chamber includes an anechoic chamber and a supporting bracket. A sidewall of the anechoic chamber defines an opening. The supporting bracket includes a shielding piece rotatably mounted to the anechoic chamber to cover the opening, and two test benches respectively fixed to two opposite side surfaces of the shielding piece. When an item of information technology equipment (ITE) is assembled to one of the test benches and the supporting bracket is rotated to make the shielding piece cover the opening and the ITE enter the anechoic chamber, the other test bench is exposed out of the chamber and another piece of ITE can be assembled thereon.

### BACKGROUND

1. Technical Field

The present disclosure relates to quality testing of information technology equipment (ITE), and particularly to an electromagnetic anechoic chamber for testing the ITE.

2. Description of Related Art

Electromagnetic or radio frequency anechoic chambers are used in quality testing of ITE, such as personal computers and liquid crystal displays. An electromagnetic anechoic chamber includes an anechoic chamber, a test bench installed in the anechoic chamber, and a receiver received in the anechoic chamber with a test antenna. In the test process, an ITE is assembled to the test bench. Turning on the ITE, electromagnetic radiation signals generated by the ITE can be received by the test antenna and further transmitted to the receiver. After the test of the ITE is accomplished, the electromagnetic anechoic chamber stops working. The ITE is disassembled from the test bench, and another ITE has to be assembled to the test bench for testing. However, assembling or disassembling the ITEs is time-consuming, in the meantime, the electromagnetic anechoic chamber does not operate, thus the usage rate of the electromagnetic anechoic chamber is reduced.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partial, exploded, and isometric view of an exemplary embodiment of an electromagnetic anechoic chamber.

FIG. 2 is an assembled, isometric view of the electromagnetic anechoic chamber of FIG. 1.

FIG. 3 is a sectional view along line of III-III of FIG. 2, showing the electromagnetic anechoic chamber in use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

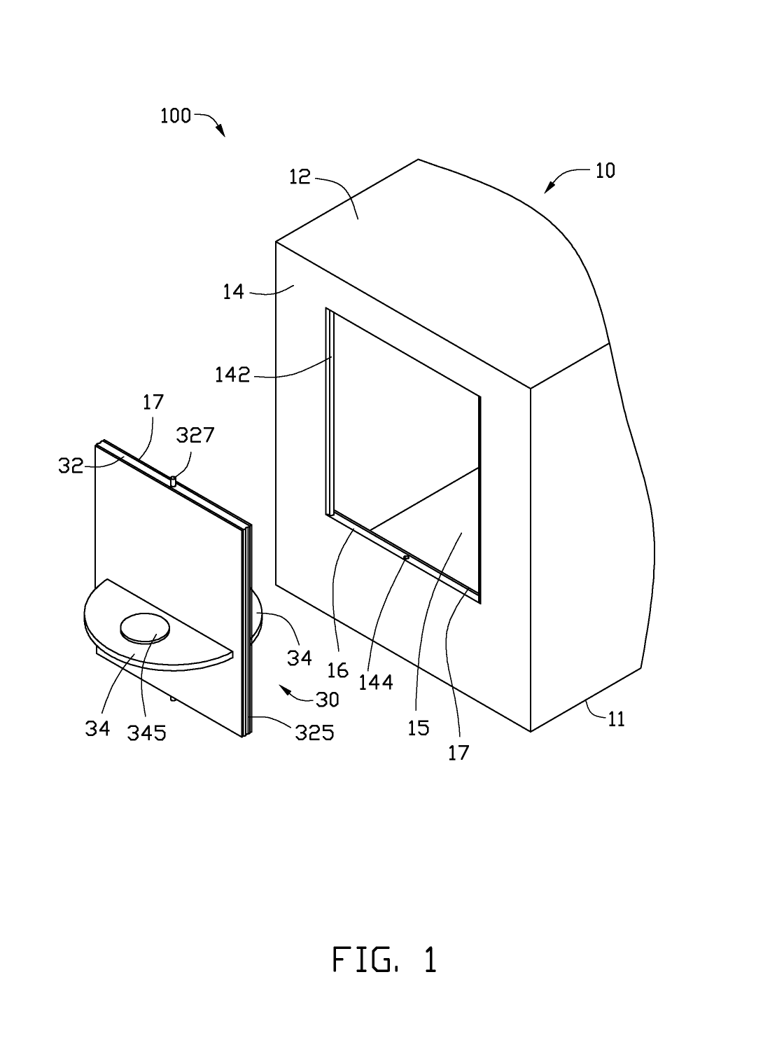

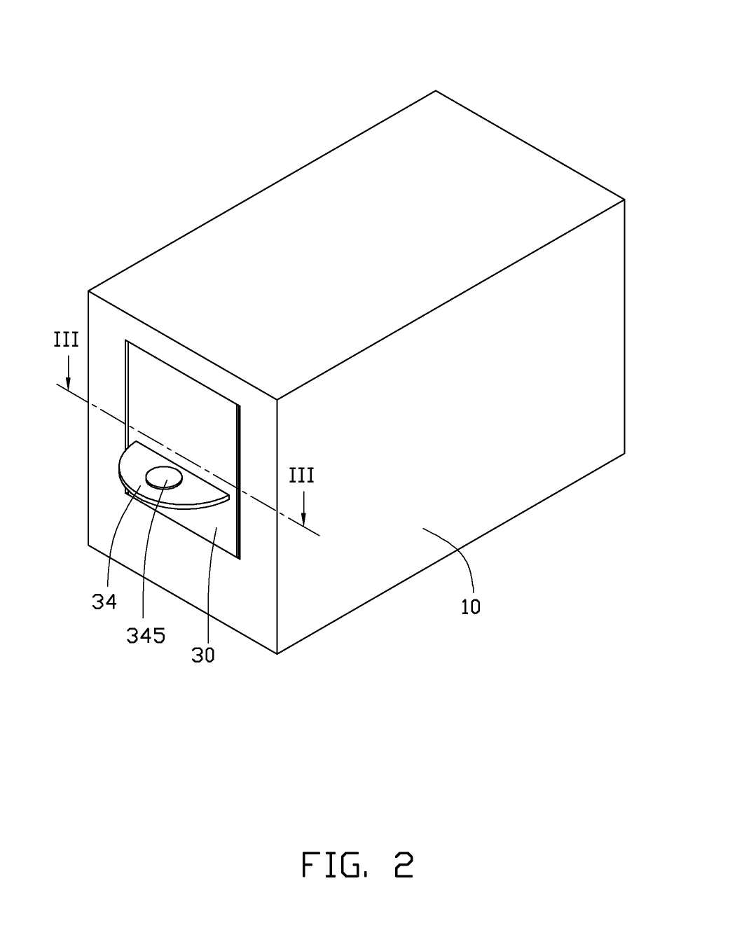

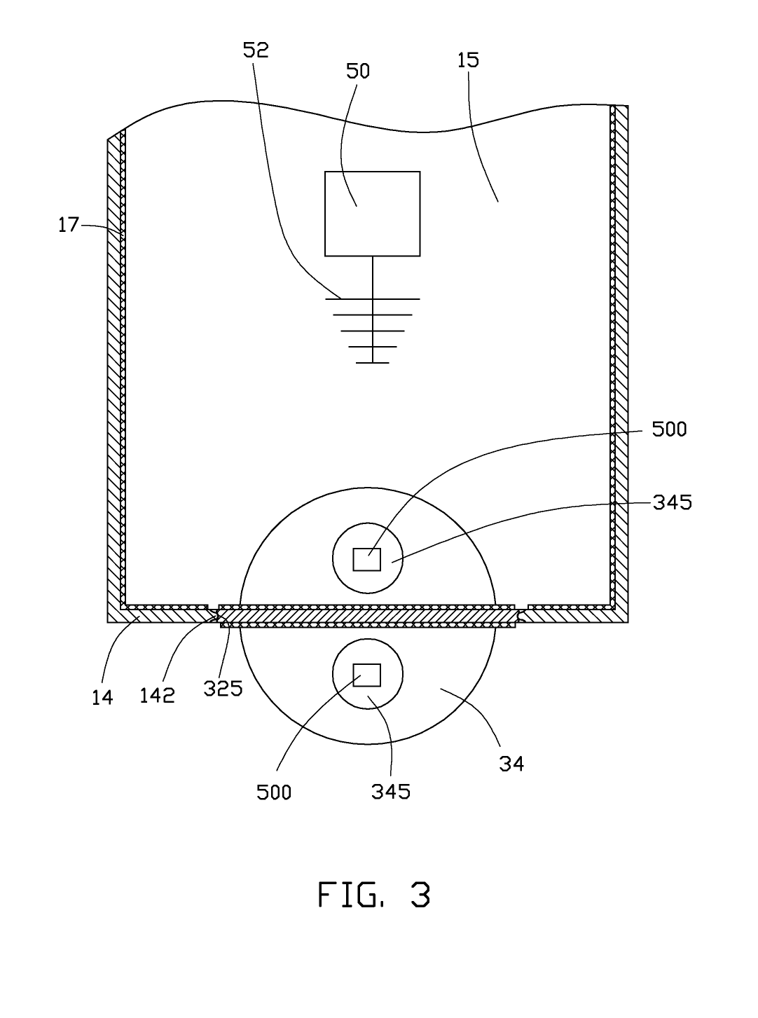

FIGS. 1-3 show an exemplary embodiment of an electromagnetic anechoic chamber 100 which can be used to measure intensity of electromagnetic radiation generated by items of information technology equipment (ITE) 500, such as personal computers, liquid crystal displays, and mobile telephones. The electromagnetic anechoic chamber 100 includes an anechoic chamber 10, a supporting bracket 30, and a receiver 50. The receiver 50 includes a test antenna 52 for receiving the electromagnetic radiation.

The anechoic chamfer 10 includes a bottom wall 11, a top wall 12, and a sidewall 14 perpendicularly connected between the bottom wall 11 and the top wall 12. The bottom wall 11, the top wall 12, and the sidewall 14 cooperatively bound a containing space 15. Electromagnetic wave absorptive material 17 is spread on inner surfaces of the top wall 12 and the sidewall 14. The sidewall 14 defines a rectangular opening 16. Two vertical resilient positioning bars 142 having arc-shaped cross-sections protrude from opposite sidewalls bounding the opening 16. Two opposite shaft holes 144 are defined in middle of a top wall and middle of a bottom wall bounding the opening 16.

The supporting bracket 30 includes a rectangular shielding piece 32 and two semicircular supporting plates 34 perpendicularly extending out from opposite side surfaces of the shielding piece 32. A test bench 345 is fixed on each of the supporting plates 34, and an item of ITE 500 is capable of being assembled on the test bench 345. Absorptive material 17 is spread on the side surfaces of the shielding piece 32. Two positioning slots 325 having concave arc-shaped cross-sections are defined in a left sidewall and a right sidewall of the shielding piece 32, along a lengthwise direction of the shielding piece 32. Two shafts 327 extend out from middle of a top wall and middle of a bottom wall of the shielding piece 32. Each shaft 327 is rotatably inserted into a shaft hole 144 of the chamber 10. Therefore, the supporting bracket 30 is rotatably mounted to the opening 16 of the anechoic chamber 10.

In use, a first item of ITE 500 is assembled on a first one of the test benches 345, and the first item of ITE 500 is powered on. The shielding piece 32 is rotated about the shafts 324, until the positioning bars 142 latch into the corresponding positioning slots 325. The shielding piece 32 covers the opening 16 to shield the anechoic chamber 10 from external electromagnetic radiation. The first test bench 345 supporting the first item of ITE 500 has been rotated into the containing space 15. Electromagnetic radiations generated by the first item of ITE 500 can be received by the test antenna 52 and further transmitted to the receiver 50. At the same time, a second item of ITE 500 can be fixed on a second one of the test benches 345 exposed out of the chamber 10. After the test of the first item of ITE 500 is finished, the shielding piece 32 is rotated 180 degrees. The second item of ITE 500 is thereby rotated into the containing space 15 for testing, and the first test bench 345 is exposed out of the chamber 10 for disassembling the first item of ITE 500, a third item of ITE 500 can then be assembled in its place.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An electromagnetic anechoic chamber, comprising:
an anechoic chamber comprising a sidewall defining an opening; and
a supporting bracket comprising a shielding piece rotatably mounted to the anechoic chamber to cover or uncover the opening, and two test benches respectively extending from opposite side surfaces of the shielding piece, when an item of information technology equipment (ITE) is assembled to one of the test benches and the supporting bracket is rotated to make the shielding piece cover the opening and the item of ITE enter the anechoic chamber for test, the other bench is exposed out of the anechoic chamfer for assembling another item of ITE.

2. The electromagnetic anechoic chamber of claim 1, wherein the supporting bracket further comprises two supporting plates extending out from the side surfaces of the shielding piece, the test benches are fixed on the corresponding supporting plates.

3. The electromagnetic anechoic chamber of claim 1, wherein electromagnetic wave absorptive material is spread on the side surfaces of the shielding piece.

4. The electromagnetic anechoic chamber of claim 1, wherein a middle of a top wall and a middle of bottom wall of the shielding piece are rotatably connected to a top wall and a bottom wall bounding the opening.

5. The electromagnetic anechoic chamber of claim 4, wherein the top wall and the bottom wall of the opening define two opposite shaft holes, two shafts extend out from the top wall and bottom wall of the shielding piece, each shaft is rotatably inserted into a corresponding shaft hole.

6. The electromagnetic anechoic chamber of claim 1, wherein two resilient positioning bars protrude out from left and right sidewalls bounding the opening, left and right sidewalls of the shielding piece define two positioning slots for respectively engaging the positioning bars.

7. The electromagnetic anechoic chamber of claim 6, wherein each positioning bar has an arc-shaped cross-section, each positioning slot has an arc-shaped cross-section.
